(19) United States
(12) Patent Application Publication
(10) Pub. No.: US 2007/0005803 A1
(43) Pub. Date: Jan. 4, 2007

(54) Methods and systems for carrying of call control signaling after handover from an IP packet switched network to a circuit switched cellular network and vice versa

(75) Inventors: Yousuf Saifullah, Flower Mound, TX (US); Srinivas Sreemanthula, Arlington, TX (US); Khiem Le, Coppell, TX (US); Stefano Faccin, Dallas, TX (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/289,365

(22) Filed: Nov. 30, 2005

Related U.S. Application Data
(63) Continuation of application No. 09/617,817, filed on Jul. 17, 2000, now abandoned.

(51) Int. Cl. G06F 15/16

(52) U.S. Cl. 709/245

(57) ABSTRACT

Methods and systems for carrying call control information after a call handover from an Internet Protocol (IP) packet switched network to a circuit switched cellular network and vice versa. The IP packet switched network includes a processing server capable of processing IP-based protocol messages. The circuit switched cellular network includes a mobile switching center. A gateway is operatively connected as a bridge between the IP packet switched network and the circuit switched cellular network. The gateway is capable of encapsulating an IP-based protocol message into a payload of a second message, and extracting an IP-based protocol message from a payload of another message. One or more user devices are capable of transmitting and receiving to/from the IP packet switched network and the circuit switched cellular network. The user devices are capable of encapsulating an IP-based protocol message into a payload of a second message, and extracting an IP-based protocol message from a payload of another message. The IP-based protocol message contains call control information that is encapsulated, transparently transferred through the switched cellular network, and extracted. The call control information is transferred between the IP packet switched network and the user device. The circuit switched cellular network may be part of a circuit switched cellular system that also includes an overlayed packet switched network. The call control information may be carried in packets between the IP packet switched network and the user device transparently through the overlayed packet switched network.

### BACKGROUND

1. Field

This invention relates to IP telephony, and more specifically to carrying of call control information after call handover from an IP packet switched network to a circuit switched cellular network and vice versa.

2. Background

The telecommunications area is an ever growing field. Telephone calls are currently primarily routed through circuit switched networks. In the past, telephone calls existed between two users over a wire connection. Now, wireless systems exist where telephone communications can be carried across wireless systems. Still, the majority of wireless telecommunications exist using circuit switching. With circuit switching, the parties that are part of a telephone or telecommunication information transfer have a dedicated circuit that has been set up to carry the voice data or other traffic between the parties or users. With circuit switching, the users are the only ones using that particular circuit to transfer voice and/or information. Virtually all voice telephone calls are currently circuit switched.

An alternative to circuit switching is packet switching. With packet switching, multiple packets from various users are sent across a network. Voice or other information transfer between one user to a second user using packet switching includes sending multiple packets containing the information from one source to the other. The packets may take different paths to arrive at the same destination. The packets are reassembled at the destination and put in the correct order to receive the voice and/or message information that was sent appropriately.

An emerging technology called IP telephony allows the transfer of voice data and video across Internet Protocol (IP) based networks. IP Telephony has also gained acceptance in the mobile community as a main stream solution for the provision of telecommunication services and also to provide the Internet connectivity to subscribers. An all IP network is currently being developed as a new type of mobile network that uses IP for mobile telephone transmissions. An all IP network is generally cheaper to use because it combines signaling and data communications into one packet (IP) network. In addition, it shall also provide a host of new multimedia services or IP application services due to IP connectivity. Also, these IP application services can now be used in accordance with the telephone transmissions.

Currently, cellular networks have a large customer base and are widely available. IP based networks that are carrying wireless telecommunication traffic may need to access an existing cellular network to transmit the traffic to the desired destination. To accomplish this, it is necessary that the IP based network be capable of supporting handovers of calls from/to circuit switched cellular networks.

However, after performing the handover of the call from the IP based network to the circuit switched cellular system network, call control information in the IP mobile network should still be anchored in the IP based call control protocol (e.g., Session Initiation Protocol (SIP), H.323) used between the mobile terminal and the call control point, and must be transparently carried over the circuit switched cellular system. However, the circuit switched cellular system doesn't understand the IP based application signals and the call control information may be dropped by the cellular system. Therefore, it is not possible to handover the call control to the circuit switched cellular system. Thus, a need exists to allow carrying call control information transparently in a circuit switched cellular system network after a call handover from an IP mobile network.

### BRIEF DESCRIPTION OF THE DRAWINGS

The present invention is further described in the detailed description which follows in reference to the noted plurality of drawings by way of non-limiting examples of the present invention in which like reference numerals represent similar parts throughout the several views of the drawings and wherein:

FIG. 1 is a system diagram showing an example path that call control information may take from a user equipment or device through a legacy system to an Internet protocol network and vice versa according to an example embodiment of the present invention;

FIG. 2 is a flow diagram showing example signaling flow for an uplink message, from a user equipment, handed over from an IP network to a legacy GSM circuit switched cellular network according to an example embodiment of the present invention;

FIG. 3 is a flow diagram showing example signaling flow for a downlink message, to a user equipment, handed over from an IP based network to a legacy GSM circuit switched cellular network according to an example embodiment of the present invention;

FIG. 4 is a system diagram of an example system where call control information is passed transparently through a circuit switched cellular system that has an overlaying packet switched network according to an example embodiment of the present invention;

FIG. 5 is a signal flow diagram showing example call control paths where a serving support node is capable of communicating with a gateway of the IP mobile network according to an example embodiment of the present invention;

FIG. 6 is a signal flow diagram of example signal paths for call control information where a serving support node is not capable of communicating with a gateway of the IP mobile network according to an example embodiment of the present invention;

FIG. 7 is a system diagram showing the path that call control information may take from user equipment through a packet switched network to a circuit switched network and vice versa according to an example embodiment of the present invention;

FIG. 8 is a flow diagram showing example signaling flow for a uplink message carrying call control information, from a user equipment, handed over from a GSM circuit switched cellular network to a packet switched IP network according to an example embodiment of the present invention; and

FIG. 9 is a flow diagram showing example signaling flow for a downlink message carrying call control information, to a user equipment, handed over from a GSM circuit switched cellular network to a packet switched IP network according to an example embodiment of the present invention.

### DETAILED DESCRIPTION

The particulars shown herein are by way of example and for purposes of illustrative discussion of the embodiments of the present invention. The description taken with the drawings make it apparent to those skilled in the art how the present invention may be embodied in practice.

Further, arrangements may be shown in block diagram form in order to avoid obscuring the invention, and also in view of the fact that specifics with respect to implementation of such block diagram arrangements is highly dependent upon the platform within which the present invention is to be implemented, i.e., specifics should be well within purview of one skilled in the art. Where specific details (e.g., circuits, flowcharts) are set forth in order to describe example embodiments of the invention, it should be apparent to one skilled in the art that the invention can be practiced without these specific details. Finally, it should be apparent that any combination of hard-wired circuitry and software instructions can be used to implement embodiments of the present invention, i.e., the present invention is not limited to any specific combination of hardware circuitry and software instructions.

Although example embodiments of the present invention may be described using an example system block diagram in an example host unit environment, practice of the invention is not limited thereto, i.e., the invention may be able to be practiced with other types of systems, and in other types of environments (e.g., servers).

Reference in the specification to “one embodiment” or “an embodiment” suggests that a particular feature, structure, or characteristic described in connection with the embodiment is included in at least one embodiment of the invention. The appearances of the phrase “in one embodiment” in various places in the specification are not necessarily all referring to the same embodiment.

The present invention relates to methods and systems of carrying call control information transparently through a circuit switched cellular system between an IP based network and a user device.

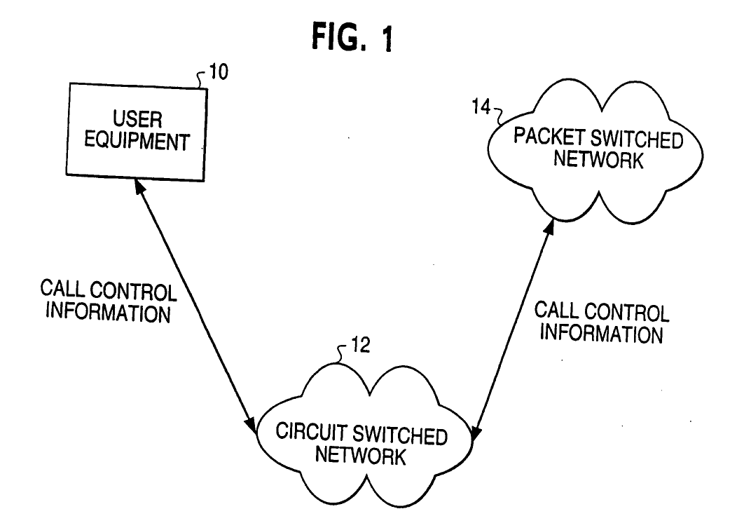

FIG. 1 is a system diagram showing the path that call control information may take from user equipment or devices through a legacy system to a packet switched network (e.g., an Internet Protocol (IP) network) and vice versa according to an example embodiment of the present invention. User equipment 10 is the source or destination of telephonic information, such as a telephone call, that is transmitted using the Internet. To illustrate the present invention, embodiments where the telephonic information is a telephone call will be used. However, the present invention is not limited to situations where the telephonic information is a telephone call, but includes any type of telephonic information or data transmission that may have related control information that is to be transmitted also. Also, embodiments where the packet switched network is shown as an IP network will be used to illustrate the present invention, however, the packet switched network may be an IP-based network, or any packet switched network and still be within the spirit and scope of the present invention. User equipment 10 may be any of a variety of devices, such as a mobile phone, personal digital assistant (PDA), laptop computer, etc., that has the capability of transmitting and receiving wireless telephonic information.

In some cases, it may be that the telephonic information transmission cannot be completed using the Internet alone. To complete the telephonic information transmission, it may be necessary to use a circuit switched network 12. Therefore, the telephonic information will use the circuit switched network of the legacy system 12 to continue the telephonic information transmission. However, the control information (e.g., call control information) may be centered at an Internet site. Call control information may not be handed over to circuit switched network 12 because the legacy system may not understand the Internet protocol call control information. Therefore, call control information is passed transparently between the Internet protocol network 14 and user device 10 through the circuit switched network 12. Call control information is information that may relate to setting up of the call, monitoring of the call, and termination of the call. Call control information may also include information related to other items, for example, call waiting, call forwarding, etc.

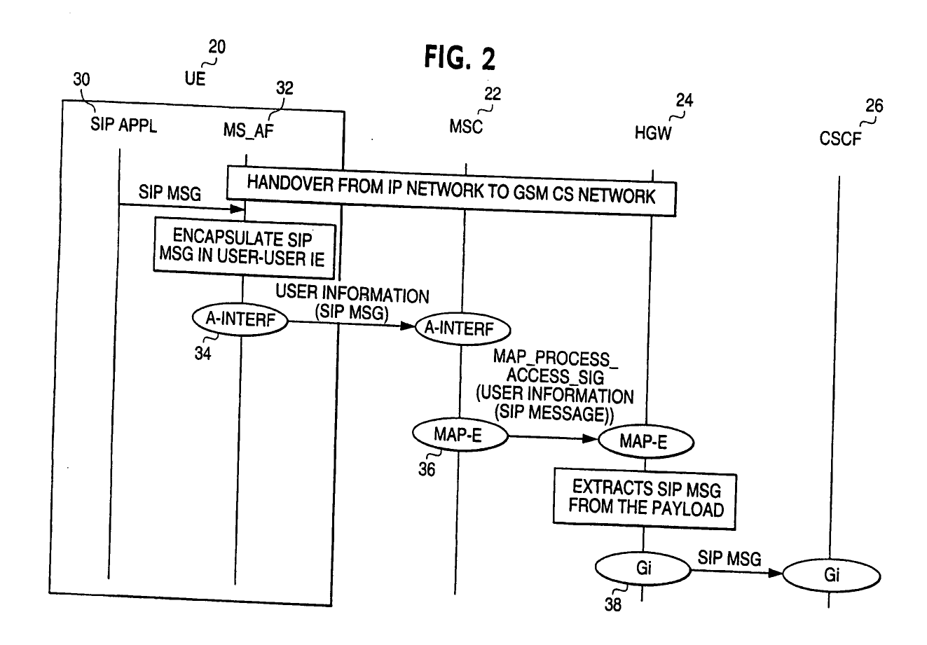

FIG. 2 is a flow diagram showing example signaling flow for an uplink message containing call control information, from a user equipment, handed over from an IP network to a Global System for Mobile Communications (GSM) circuit switched cellular network according to an example embodiment of the present invention. FIG. 2 shows the routing of call control information from user equipment (UE) 20 to a network element (e.g., mobile switching center (MSC)) 22 to a handoff gateway (HGW) 24 and then finally to a call state control function (CSCF) 26 that may be a call processing server connected to an IP network. Network element 22 may be any network element responsible for call switching and call control in the network. To illustrate the present invention, embodiments will be discussed where the network element is a mobile switching center, however, any network element that performs these functions are within the spirit and scope of the present invention. A Session Initiation Protocol (SIP) application 30, resident at user equipment 20, is an entity that receives and responds to all call control messages that are in the form of an SIP message. Session Initiation Protocol is an open, simple Internet-friendly protocol designed for initiating, managing, and terminating interactive sessions.

SIP application 30 sends a SIP message containing call control related information to a mobile station adaptation function (MS_AF) 32 that is resident at user equipment 20. After a call handover from the IP based network to the circuit switched system, the mobile station adaptation function 32 knows that the transport network is a circuit switched network. When the mobile station adaption function 32 receives the SIP message from the SIP application, the mobile station adaption function encapsulates the SIP message into a user-user data in a user information message.

The user information message containing the SIP message as a payload is sent from user equipment 20 to mobile switching center 22 using interface logic 34 that resides at the user equipment 20. A version of interface logic 34 also resides at the mobile switching center 22 to receive the user Information message. A user information message is a message used in legacy GSM circuit switched systems to transfer user to user data where the GSM system transports the message without intercepting or looking into the user to user data. Mobile switching center 22 is a network element responsible for call switching and call control in a wireless network. The mobile switching center receives the user information message and because of the type of message, knows that it can just transfer the message. The mobile switching center puts the user information message (that has a payload of the SIP message), into a Map_Process_Access_Sig message. Mobile switching center 22 then sends the Map_Process_Access_Sig message, which contains a payload of the user information message, to handoff gateway 24 using interface logic 36. Interface logic 36 exists on both the mobile switching center 22 and handoff gateway 24. The handoff gateway is part of an IP based mobile network and performs signaling and media conversion from the circuit switched network to a packet switched domain and vice versa. User information messages and Map_Process_Access_Sig messages are known GSM messages that are passed through a GSM network without being touched. Handoff gateway 24 receives the Map_Process_Access_Sig message and extracts the SIP message from the payload. The SIP message containing the call control related information is then sent from handoff gateway 24 to the call state control function 26 using interface logic 38. Call state control function 26 may be a call processing server that is part of an IP based network.

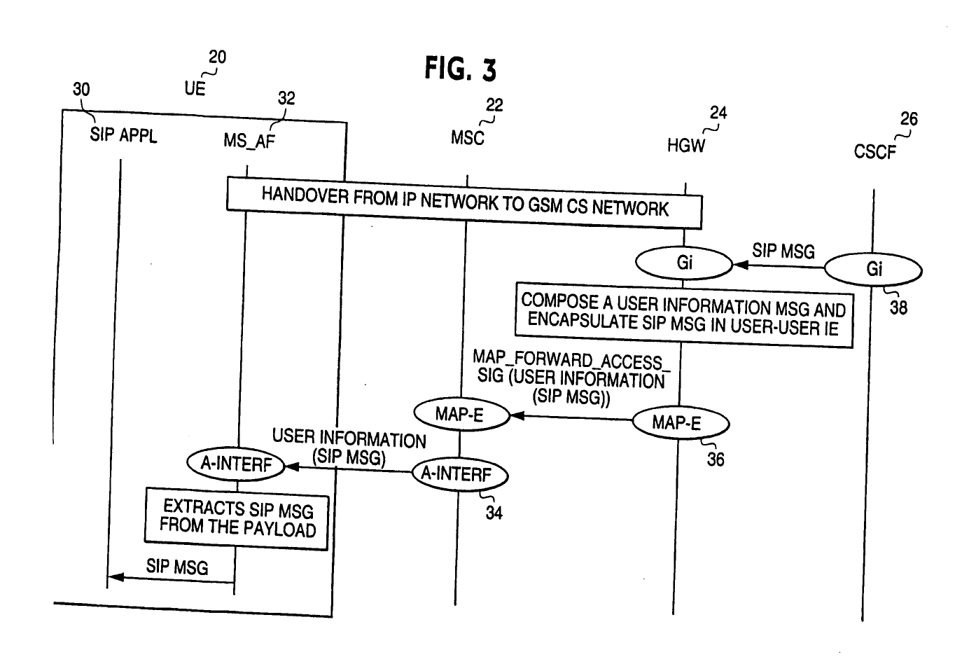

FIG. 3 is a flow diagram showing example signaling flow for a downlink message carrying call control information, to a user equipment, handed over from an IP based network to a circuit switched cellular network according to an example embodiment of the present invention. Call control related information is placed in a SIP message at call state control function 26 (on an IP network) and sent to handoff gateway 24 using interface logic 38. Handoff gateway 24 composes a user information message and encapsulates the SIP message into the user-to-user information message. Handoff gateway 24 further takes the user information message and uses it as a payload as part of a Map_Forward_Access_Sig message, which is then sent to mobile switching center 22. Mobile switching center 22 receives the user information payload contained in the Map_Forward_Access_Sig message and forwards the user information message to the mobile station adaption function 32 contained in user equipment 20. The mobile station adaption function 32 extracts the SIP message from the user information payload and sends the SIP message to the SIP application contained in user equipment 20.

Therefore, call control information is handed off from the IP network (containing the call state control function server 26) through the circuit switched system (that includes mobile switching center 22) to user equipment 20, where the circuit switched system transparently passes the call control information without intercepting it.

FIGS. 2 and 3 show an example embodiment of the present invention where the circuit switched network is a GSM network. However, the present invention is not limited to a GSM based network but may be applied to any circuit switched network, such as, for example, an Interim Standard (IS)-41 circuit switched network as used in North America. FIGS. 2 and 3 can be applied to an IS-41 circuit switched network. For this, the IS-41 circuit switched network (or any other circuit switched network) would need to define messages analogous to the GSM user information message, Map_Process_Access_Sig message, and Map_Forward_Access_Sig message that are defined to be transmitted untouched through the network. IS-41 type messages will be defined such that when these messages are sent through the IS-41 circuit switched network, the IS-41 network would not open, interpret, or intercept these messages, but would simply transparently transport these messages.

Further, the encapsulation process and/or logic and extraction process and/or logic that reside on the user equipment and the handoff gateway may also need to be customized for an IS-41 circuit switched network (or other circuit switched network that is used). The present invention may be applied using other circuit switched networks, such as, for example, IS-136. Regardless of what circuit switched system is used, messages may need to be defined whereby the legacy system will interpret the messages and payload, and not intercept the messages but transfer the messages transparently through the circuit switched system. The present invention was illustrated using an embodiment of a GSM circuit switched network because GSM has existing messages and payloads (e.g., user information message) that are already interpreted to be transferred transparently. Further, other call control mechanisms or protocols for IP based networks may be used to transfer call control information. In the example embodiment, a SIP message was used, however, other IP based protocols may also be used to transfer call control information such as, for example, an H.323 call control protocol.

Therefore, according to one aspect of the present invention, call control information may be transported through a circuit switched system transparently and not intercepted by the circuit switched system. Further, according to the present invention, this may be accomplished without adding any changes to the circuit switched system. Only the handoff gateway and user equipment may need added functionality.

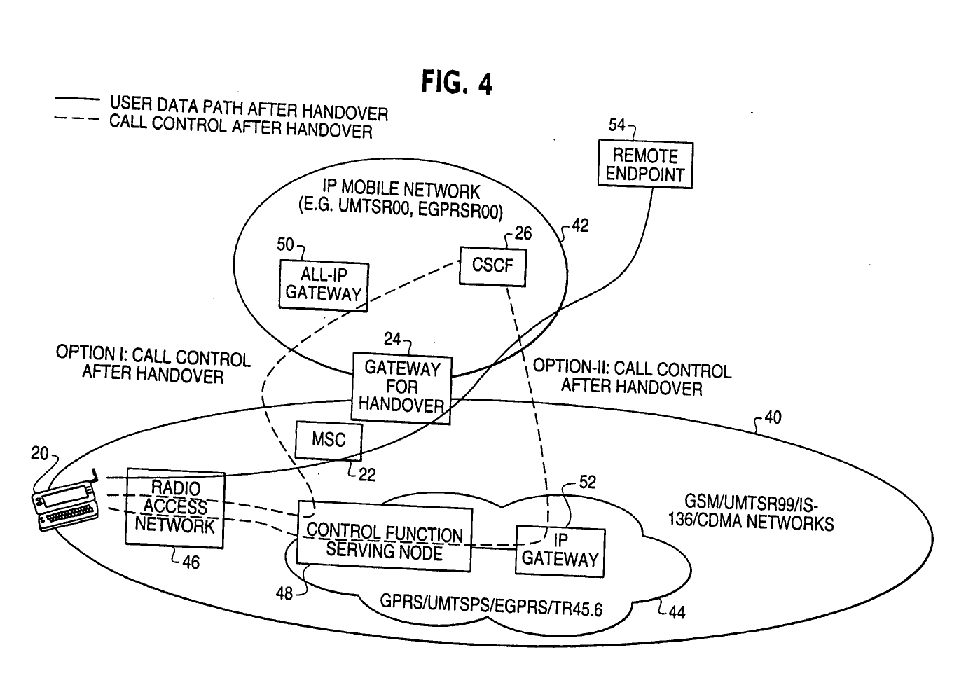

FIG. 4 shows a system diagram of an example system where call control information is passed transparently through a circuit switched cellular system that has an overlaying packet switched network according to an example embodiment of the present invention. Cellular system 40 includes a circuit switched network and any packet switched network 44. The circuit switched network may be any circuit switched network such as, for example, GSM, Universal Mobile Telecommunication System (UMTS) R99, IS-136, or Call Division Multiple Access (CDMA) networks. The packet switched network 44 may be any packet switched network such as, for example, a General Packet Radio Service (GPRS) network, a UMTS PS (packet switch), EDGE (Enhanced Data Rates for GSM Evolution) General Packet Radio Service (EGPRS), or TR45.6 (a standards workgroup, also known as Adjunct Wireless Packet Data Technology, developing packet networks for CDMA based mobile networks).

The circuit switch network has the capacity to interface with an IP packet switched network 42 via a gateway 24. In the embodiment shown in FIG. 4, the IP packet switched network is a mobile network. The circuit switched network includes a radio access network 46 that provides radio access to user equipment 20 and manages all radio related functions. The circuit switched network may further include a mobile switching center 22 which is responsible for call switching and call control in a wireless network. The overlaying packet switched network 44 may include a control function/serving node 48 and an IP gateway 52. The control function/serving node (e.g., 2G-SGSN, 3G-SGSN, PCF) in the packet switched network provides packet control functions that may include mobility management and session management as defined in the corresponding standards. The IP gateway 52 may be a second generation (2G) IP gateway. The IP mobile network 42 may include an all-IP gateway 50 (that may be a third generation (3G) IP gateway) and a call state control function (CSCF) call processing server 26.

Remote End Point 54 is operably connected to IP mobile network 42 and may receive or send information from/to network 42. It is possible that Remote End Point 54 is in a PSTN (public switched telephone network) in which case it is connected to the IP mobile network through some control function nodes and media gateway (not shown in FIG. 4). The solid line in FIG. 4 shows the user data path after handover of a call from the IP mobile network 42 to the circuit switched network. The dashed line in FIG. 4 displays the path that call control information may follow after handover of a call. IP gateway 52 may be a gateway GPRS support node (GGSN) that provides GSM/UMTS connectivity to external data networks such as the Internet. Control function/serving node 48 may be a serving GPS support node (SGSN) that provides connectivity between a radio access network 46 and IP gateway 52. The serving GPRS support node provides key functions such as mobility management, session management, charging (billing), etc.

In this embodiment of the present invention, call control information may be passed between user equipment 20 and the call state control function 26 on the IP mobile network 42 via the radio access network 46, control function/serving node 48, and all IP gateway 50. Moreover, call control information may be passed between user equipment 20 and the call state control function 26 on the IP mobile network 42 via radio access network 46, control function/serving node 48, and IP gateway 52 when control function/serving node 48 is not capable of communicating with all IP gateway 50.

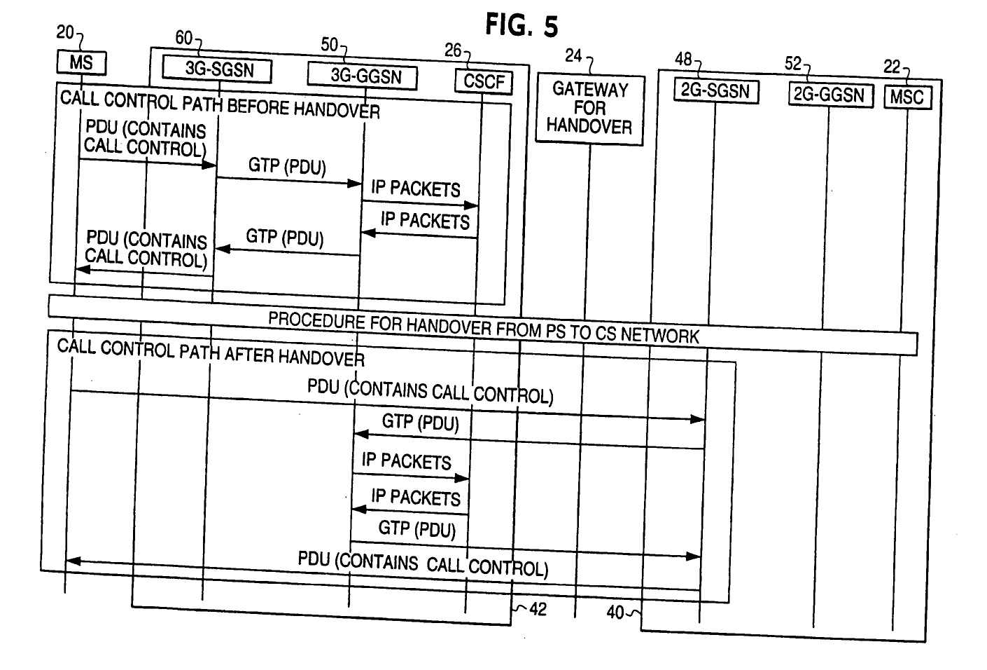

FIG. 5 shows a signal flow diagram showing example call control paths before and after call handover where a serving node 48 (e.g., 2G serving GPRS support node), that is part of the overlaying packet switched network, is capable of communicating with an all IP gateway 50 (e.g., 3G gateway GPRS support node) of the IP mobile network 42. The call control path before handover is shown in the upper portion of FIG. 5 while the call control path after handover is shown in the lower portion of FIG. 5.

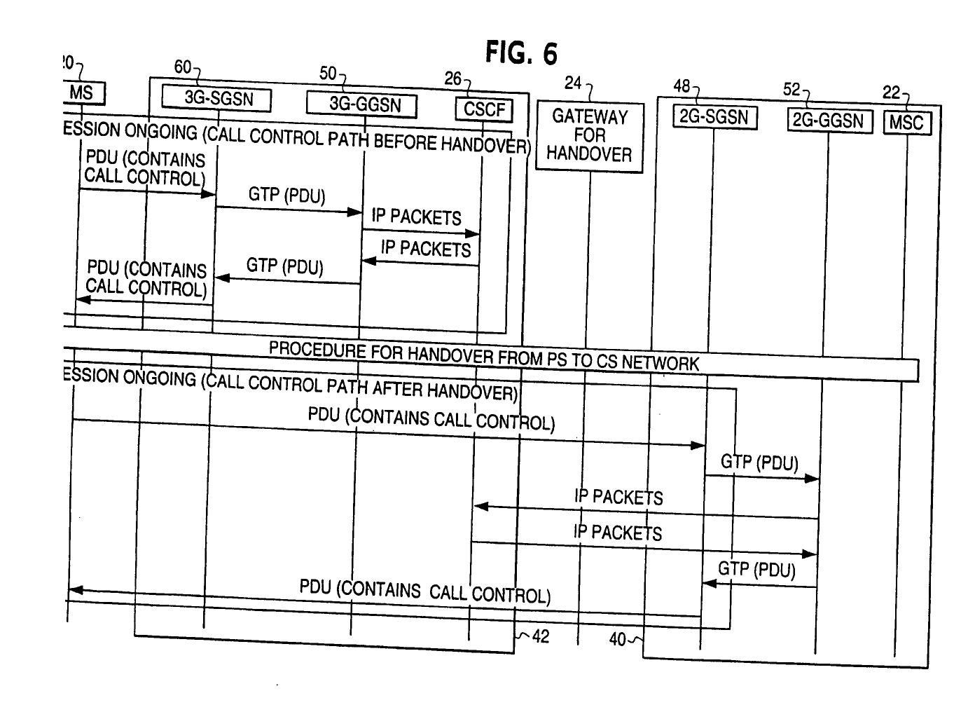

Before handover, user equipment 20 (shown as mobile station (MS) in FIGS. 5 and 6) sends call control related information via a Protocol Data Unit (PDU). A PDU is a generic packet that may contain a payload carrying a message. The PDU containing call control information payload is sent from user equipment 20 to a 3G-serving GPRS support node (SGSN) 60 (which is part of IP mobile network 42 but not shown). The serving GPRS support node 60 encapsulates the PDU to a GTP (GPRS Tunnelling Protocol) packet and sends it to the 3G gateway GPRS support node (GGSN) 50. 3G gateway GPRS support node 50 extracts the IP packets containing the call control information and forwards this to the call state control function server (CSCF) 26.

Similarly, call control information is carried from call state control function server 26 to user equipment 20 by putting the call control information in IP packets at the call state control function server and sending the packets to the 3G gateway GPRS support node 50. 3G gateway GPRS support node 50 encapsulates the packet information into a GTP packet and forwards this to 3G serving GPRS support node 60. 3G serving GPRS support node 60 extracts the PDU with the call control information payload and forwards it to user equipment 20.

According to the present invention, after a call has been handed over from IP mobile network 42 to any circuit switched network 40 with an overlaying packet switched network 44, call control information is routed via a different path. User equipment 20 sends the PDU containing call control information to 2G serving GPRS support node 48. This is via radio access network 46. 2G serving GPRS support node 48 then encapsulates the PDU packet into a GTP packet and forwards this to 3G gateway GPRS support node 50 at the IP mobile network 42. 3G gateway GPRS support node 50 extracts the IP packets containing the control information and forwards this to the call state control function server 26.

Conversely, call control information to be sent from the call state control function server 26 to the user equipment 20 is put into packets by the call state control function server 26 and sent to the 3G gateway GPRS support node 50. 3G gateway GPRS support node 50 encapsulates these packets into a GTP packet and forwards this to the 2G serving GPRS support node 48. 2G serving GPRS support node 48 extracts the PDU packet containing the call control information and forwards this to the user equipment 20 (via radio access network 46).

FIG. 6 shows a signal flow diagram of example signal paths for call control information where a GPRS IP gateway (e.g., 2G serving GPRS support node) is not capable of communicating with an all IP gateway (3G gateway GPRS support node) at an IP based mobile network according to an example embodiment of the present invention. The call control path for before handover is the same as shown in FIG. 5. The bottom portion of FIG. 6 shows the call control path after handover. Here, user equipment 20 may put call control related information as a payload in a PDU packet and send the PDU packet to 2G serving GPS support node 48. 2G serving GPS support node 48 then encapsulates the PDU packet into a GTP packet and forwards this to 2G gateway GPRS support node 52. 2G gateway GPRS support node 52 extracts the IP packets containing the call control information and forwards this to the call state control function server 26. In the other direction, call state control function server 26 may send call control information in a packet to 2G gateway GPRS support node 52. 2G gateway GPRS support node 52 may then encapsulate the packet into a GTP packet and forward this to 2G serving GPRS support node 48. 2G serving GPRS support node 48 extracts the PDU packet containing the call control information payload and forwards this to user equipment 20.

Thus, one advantage of the present invention in that it provides a way for carriers to deploy IP based mobile networks and provides full mobility by providing support for handovers to their circuit switched cellular network. According to the present invention, all Internet protocol call control messages are sent as user data without being intercepted by circuit switched network elements. In one embodiment of the present invention, an encapsulation/decapsulation mechanism in user equipment can encapsulate and decapsulate Internet protocol (e.g., session initiation protocol) call control messages as a user to user information when the user equipment is in a legacy network. An encapsulation/decapsulation mechanism in a handoff gateway can encapsulate/decapsulate session initiation protocol (or any other IP based protocol) call control information from a legacy call control message (e.g., user_information message). In another embodiment of the present invention, if a packet switched network exists in the circuit switched network to be handed over to, the IP signaling information could be carried over that packet switched network. Therefore, according to the present invention, IP based mobile traffic (including IP call control messages) may be carried through circuit switched cellular networks with no change to the circuit switched cellular networks.

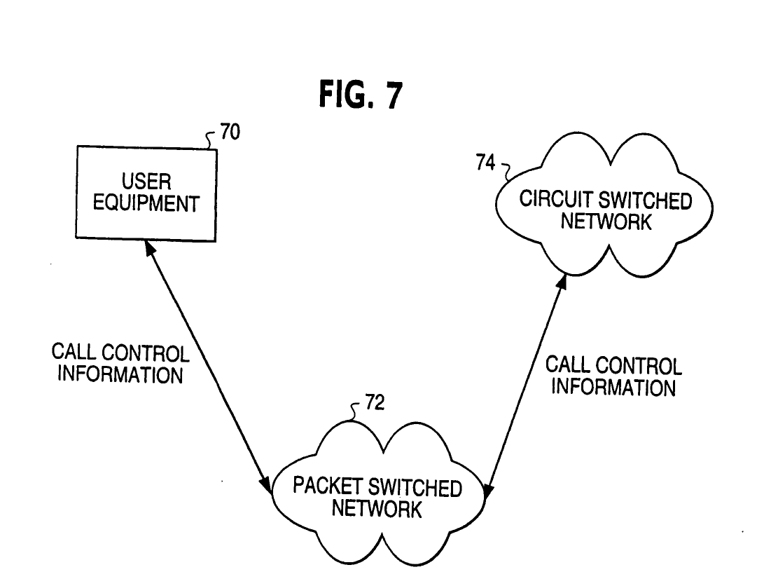

FIG. 7 is a system diagram showing the path that call control information may take from user equipment through a packet switched network to a circuit switched network and vice versa according to an example embodiment of the present invention. Telephonic information may be transmitted between user equipment 70 and another user using circuit switched network 74. It may be necessary to handover the telephonic information transmission or call to a packet switched IP network 72, to complete or continue the call. Call control information may be based in the circuit switched network, but also needs to continue to be communicated. However, it may not be possible to handover call control information to the packet switched IP network (or other packet switched network) since the packet switched network may not understand the circuit switched network call control information. Therefore, the call control information may be transparently carried through the packet switched network 72 between user equipment 70 and circuit switched network 74.

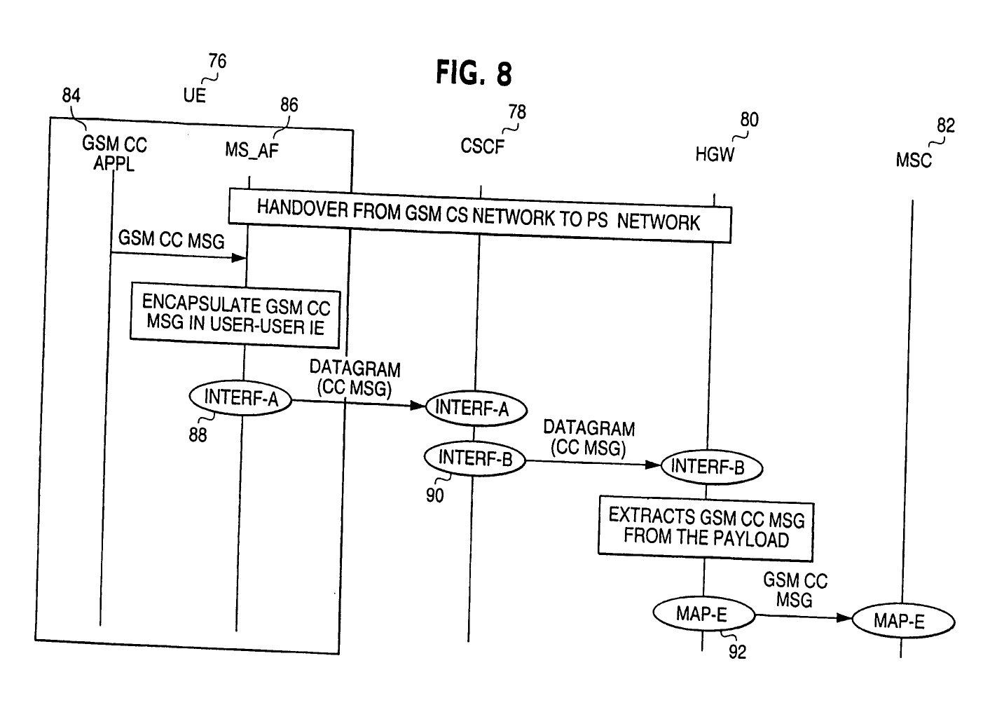

FIG. 8 is a flow diagram showing example signaling flow for a uplink message carrying call control information, from a user equipment, handed over from a GSM circuit switched cellular network to a packet switched IP network according to an example embodiment of the present invention. FIG. 5 shows the routing of call control information from user equipment (UE) 76 to a call state control function (CSCF) 78 to a handoff gateway (HGW) 80 and then finally to a mobile switching center (MSC) 82. A GSM call control (CC) application 84, resident at user equipment 76, is an entity that receives and responds to all call control messages that are in the form of a GSM message.

GSM CC application 84 sends a GSM message containing call control related information to a mobile station adaptation function (MS_AF) 86 that is resident at user equipment 84. After a call handover from a circuit switched network (e.g., 74) to a packet switched network (e.g., 72), the mobile station adaptation function 86 knows that the transport network is a packet switched (PS) network. When the mobile station adaption function 86 receives the GSM message from the GSM CC application 84, the mobile station adaption function encapsulates the GSM message into user-user data in a datagram message. The datagram may be specific to the packet switched network, or just a datagram that the packet switched network is familiar.

The datagram message containing the GSM call control message as a payload is sent from user equipment 84 to call state control function 78 using interface logic 88 that resides at the user equipment 84 and at the call state control function 78 to receive the datagram message. The datagram is a message defined in the packet switched network to transfer user to user data where the packet switched network transports the message without intercepting or looking into the user to user data. The call state control function (CSCF) 78 receives the datagram message and because of the type of message, knows that it can just transfer the message. The call state control function 78 may further enacpsulate the datagram message (that has a payload of the GSM call control message), into one or more messages depending on the particular packet switched network and circuit switched network and application.

Call state control function 78 then sends the datagram message (or further encapsulated datagram message(s)), which contains a payload of the GSM call control message, to handoff gateway 80 using interface logic 90. Interface logic 90 exists on both the call state control function 78 and handoff gateway 80. The handoff gateway may perform signaling and media conversion from a packet switched network domain to a circuit switched network and vice versa. The datagram message (or further encapsulated datagram message(s)) are messages that are defined to be passed through the packet switched network without being touched.

Mobile switching center 82 receives the datagram message and extracts the GSM call control message from the payload. The GSM call control message containing the call control related information may then be sent from mobile switching center 82 to a call control center of the circuit switched network.

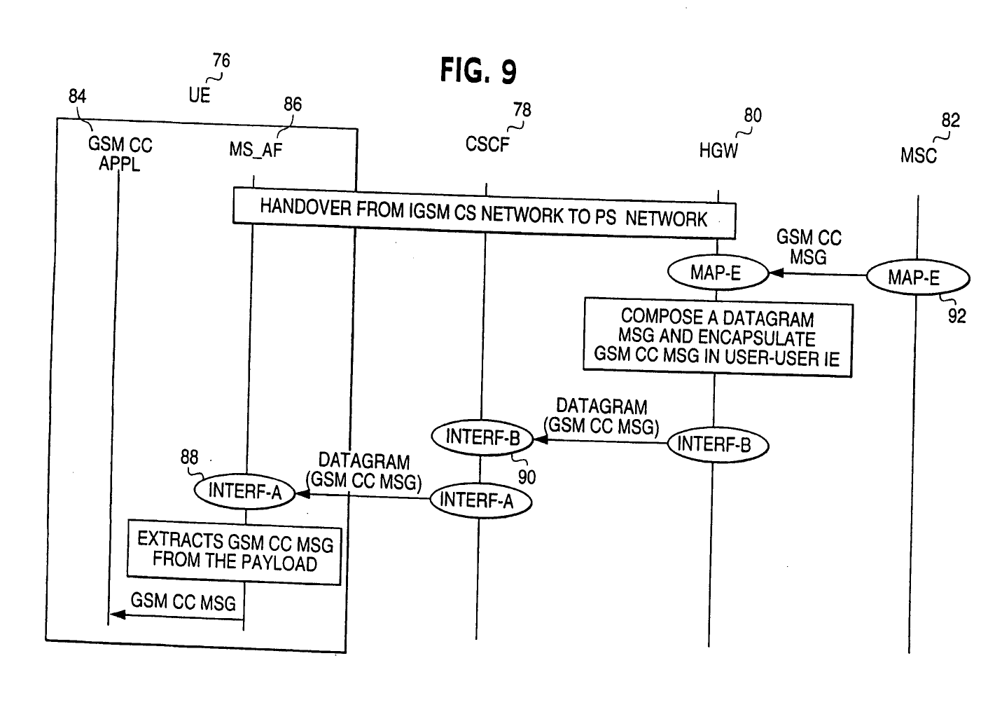

FIG. 9 is a flow diagram showing example signaling flow for a downlink message carrying call control information, to a user equipment, handed over from a GSM circuit switched cellular network to a packet switched IP network according to an example embodiment of the present invention. Call control related information may be placed in a GSM call control message at mobile switching center 82 and sent to handoff gateway 80 using interface logic 92. Handoff gateway 80 composes a datagram message and encapsulates the GSM call control message into the datagram message. Handoff gateway 80 may further take the datagram message and use it as a payload as part of one or more messages, the final message of which is then sent to call state control function 78. Call state control function 78 receives the datagram message and forwards the datagram message to user equipment 76. A mobile station adaption function 86 at user equipment 76 extracts the GSM call control message from the datagram payload and sends the GSM call control message to a GSM CC application contained in user equipment 76.

It is noted that the foregoing examples have been provided merely for the purpose of explanation and are in no way to be construed as limiting of the present invention. While the present invention has been described with reference to an embodiment, it is understood that the words which have been used herein are words of description and illustration, rather than words of limitation. Changes may be made within the purview of the appended claims, as presently stated and as amended, without departing from the scope and spirit of the present invention in its aspects. Although the present invention has been described herein with reference to particular methods, materials, and embodiments, the present invention is not intended to be limited to the particulars disclosed herein, rather, the present invention extends to all functionally equivalent structures, methods and uses, such as are within the scope of the appended claims.

What is claimed is:

1. A method for carrying call control information after a call handover from an Internet Protocol (IP) packet switched network to a circuit switched cellular network comprising:
generating a first message containing call control information, the first message being of an IP-based protocol;
encapsulating the first message into a second message;
transferring the second message to a network element, the network element being part of a circuit switched cellular network;
encapsulating, at the network element, the second message into a third message;
transferring the third message to a gateway;
extracting, at the gateway, the first message from the third message; and
sending the first message to a server in an IP packet switched network,
wherein the first message is carried through the circuit switched network transparently.

2. The method according to claim 1, wherein the IP-based protocol is one of a Session Initiation Protocol (SIP) and a H.323 protocol.

3. The method according to claim 1, wherein the circuit switched cellular network is a Global System for Mobile Communications (GSM) network.

4. The method according to claim 3, wherein the second message comprises a User Information message.

5. The method according to claim 3, wherein the third message comprises a MAP_PROCESS_ACCESS_SIG message.

6. The method according to claim 1, wherein the circuit switched cellular network is an IS-41 network.

7. The method according to claim 1, wherein the circuit switched cellular network is an IS-136 network.

8. The method according to claim 1, wherein the generating and first encapsulating are performed at a user device.

9. The method according to claim 8, wherein the user device comprises a mobile device.

10. The method according to claim 9, wherein the user device comprises one of a mobile phone, a portable computer, and a Personal Digital Assistant (PDA).

11. The method according to claim 1, the IP packet switched network comprising an IP packet switched mobile network.

12. The method according to claim 1, the network element comprising a Mobile Switching Center (MSC).

13. A method for carrying call control information after a call handover from an Internet Protocol (IP) packet switched network to a circuit switched cellular network comprising:
generating, at an IP packet switched network, a first message containing call control information, the first message being of an IP-based protocol;
encapsulating, at a gateway, the first message into a second message;
encapsulating, at the gateway, the second message into a third message;
transferring the third message to a network element, the network element being part of a circuit switched cellular network;
transferring the second message to a user device;
extracting, at the user device, the first message from the second message; and
sending the first message to an application at the user device,
wherein the first message is carried through the circuit switched network transparently.

14. The method according to claim 13, wherein the IP-based protocol is one of a Session Initiation Protocol (SIP) and a H.323 protocol.

15. The method according to claim 13, wherein the circuit switched cellular network is a Global System for Mobile Communications (GSM) network.

16. The method according to claim 15, wherein the second message comprises a User Information message.

17. The method according to claim 15, wherein the third message comprises a MAP_PROCESS_ACCESS_SIG message.

18. The method according to claim 13, wherein the circuit switched cellular network is an IS-41 network.

19. The method according to claim 13, wherein the circuit switched cellular network is an IS-136 network.

20. The method according to claim 13, wherein the generating is performed at an IP packet switched network.

21. The method according to claim 13, wherein the user device comprises a mobile device.

22. The method according to claim 12, wherein the user device comprises one of a mobile phone, a portable computer, and a Personal Digital Assistant (PDA).

23. The method according to claim 13, the IP packet switched network comprising an IP packet switched mobile network.

24. The method according to claim 13, the network element comprising a Mobile Switching Center (MSC).

25. A system for carrying call control information after a call handover from an Internet Protocol (IP) packet switched network to a circuit switched cellular network comprising:
an IP packet switched network, the IP packet switched network including a processing server, the processing server capable of processing IP-based protocol messages;
a network element, the network element being part of a circuit switched cellular network;
a gateway, the gateway operatively connected to the IP packet switched network and the circuit switched cellular network, the gateway capable of encapsulating an IP-based protocol message into a payload of a second message, the gateway further capable of extracting an IP-based protocol message from a payload of another message;
at least one user device, capable of transmitting and receiving to/from the IP packet switched network and the circuit switched cellular network, the at least one user device capable of encapsulating an IP-based protocol message into a payload of a second message, the at least one user device further capable of extracting an IP-based protocol message from a payload of another message,
wherein the IP-based protocol message comprises call control information that is encapsulated, transparently carried through the switched cellular network, and extracted, the call control information being carried between the IP packet switched network and the at least one user device.

26. The system according claim 25, wherein the user device comprises one of a mobile phone, a portable computer, and a Personal Digital Assistant (PDA).

27. The system according to claim 25, wherein the IP-based protocol comprises one of a Session Initiation Protocol (SIP) and a H.323 protocol.

28. The system according to claim 25, wherein the circuit switched cellular network comprises a Global System for Mobile Communications (GSM) network.

29. The system according to claim 25, wherein the circuit switched cellular network comprises an IS-41 network.

30. The system according to claim 25, wherein the circuit switched cellular network comprises an IS-136 network.

31. The system according to claim 25, wherein the IP packet switched network comprises an IP packet switched mobile network.

32. The system according to claim 25, wherein the network element comprises a Mobile Switching Center (MSC).

33. A system for carrying call control information after a call handover from an Internet Protocol (IP) packet switched network to a circuit switched cellular network comprising:
a first packet switched network;
a circuit switched cellular system, the circuit switched cellular system comprising a circuit switched cellular network and a second packet switched network;
at least one user device, the at least one user device operatively connected to the IP packet switched network and the circuit switched cellular system,
wherein call control information is carried in packets between the IP packet switched network and the at least one user device transparently through the second packet switched network.

34. The system according to claim 33, further comprising a radio access network, the at least one user device operatively connected to the circuit switched cellular system via the radio access network.

35. The system according to claim 27, further comprising a call processing server, the call processing server being part of the first packet switched network.

36. The system according to claim 35, further comprising a first packet switched gateway, the first packet switched gateway being part of the first packet switched network and operatively connected to the call processing server.

37. The system according to claim 36, further comprising a serving node, the serving node being part of the second packet switched network and operatively connected to the radio access network and the first packet switched gateway, the serving node capable of carrying the packets between the at least one user device through the radio access network and the first packet switched gateway.

38. The system according to claim 37, further comprising a second packet switched gateway operatively connected to the serving node and the call processing server, the second packet switched gateway capable of carrying the packets between the serving node and the call processing server.

39. The system according to claim 36 the first packet switched gateway comprising a third generation (3G) IP gateway.

40. The system according to claim 37, wherein the serving node comprises a serving GPRS support node (SGSN).

41. The system according to claim 38, wherein the second packet switched gateway comprises a gateway GPRS support node (GGSN).

42. The system according to claim 38, wherein the second packet switched gateway comprises a second generation (2G) IP gateway.

43. The system according to claim 33, wherein the second packet switched network comprises a General Packet Radio Service (GPRS) network.

44. An article comprising a storage medium having instructions stored therein, the instructions when executed causing a computing device to perform at least one of:
generating a first message containing call control information, the first message being of an IP-based protocol;
encapsulating the first message into a second message; and
transferring the second message to a network element, the network element being part of a circuit switched cellular network; and
receiving a second message from a network element, the network element being part of a circuit switched cellular network, the second message containing a first message, the first message containing call control information, the first message being of an IP-based protocol; and
extracting the first message from the second message,
wherein the first message is carried between a user device and a packet switched network through the circuit switched cellular network transparently.

45. An article comprising a storage medium having instructions stored therein, the instructions when executed causing a computing device to perform at least one of:
receiving a second message from a network element, the network element being part of a circuit switched cellular network, the second message containing a first message, the first message containing call control information, the first message being of an IP-based protocol;
extracting the first message from the second message; and
sending the first message to a server in a packet switched network; and
receiving a first message from a packet switched network, the first message containing call control information, the first message being of an IP-based protocol;
encapsulating the first message into a second message;
encapsulating the second message into a third message; and
carrying the third message to a network element, the network element being part of a circuit switched cellular network,
wherein the first message is carried between a user device and a packet switched network through the circuit switched cellular network transparently.

46. A method for carrying call control information after a call handover from a circuit switched cellular network to an Internet Protocol (IP) packet switched network comprising:
generating a first message containing call control information, the first message being of a circuit switched protocol;
encapsulating the first message into a second message;
transferring the second message to a server in an IP packet switched network;
transferring the second message to a gateway;
extracting, at the gateway, the first message from the second message; and
sending the first message to a network element, the network element being part of a circuit switched cellular network;
wherein the first message is carried through the packet switched network transparently.

47. A method for carrying call control information after a call handover from an Internet Protocol (IP) packet switched network to a circuit switched cellular network comprising:
generating, at a network element, a first message containing call control information, the network element being part of a circuit switched cellular network;
encapsulating, at a gateway, the first message into a second message;
transferring the second message to a server in an IP packet switched network;
transferring the second message to a user device;
extracting, at the user device, the first message from the second message; and
sending the first message to an application at the user device,
wherein the first message is carried through the packet switched network transparently.
